(19) United States
(12) Patent Application Publication
(10) Pub. No.: US 2009/0110554 A1
(43) Pub. Date: Apr. 30, 2009

(54) Wind Turbine for Generating Electricity

(75) Inventors: Adem D. Dukovic, Westminster, CA (US); Baichandra S. Pandya, Anaheim, CA (US); Tomislav Stefanovic, Huntington Beach, CA (US); Marvin A. Winegar, Laguna Hills, CA (US)

Correspondence Address: HENSLEY KIM & HOLZER, LLC, 1660 LINCOLN STREET, SUITE 3000, DENVER, CO, 80264, US

(73) Assignee: Wind Energy Group, Inc., Irvine, CA (US)

(21) Appl. No.: 11/587,620

(22) PCT Filed: May 3, 2005
(86) PCT No.: PCT/US05/15148

§ 371 Date: Oct. 8, 2007

Related U.S. Application Data
(60) Provisional application No. 60/568,063, filed on May 3, 2004.

(51) Int. Cl. F03D 7/06; F03D 3/06; F03D 11/04

(52) U.S. Cl. 416/41; 416/223 R; 416/204 R; 290/55

(57) ABSTRACT

A wind driven turbine (2) has a plurality of sigmoid blades (6) with the trailing edge (56) of each blade (6) mounted parallel to a horizontally oriented shaft (4). Each blade (6) extends radially outward from the shaft (4). An electric generation system is composed of an array of the turbines (2) mounted on a platform (54) positioned on top of a tower (86). Each turbine shaft (4) may be connected directly with a generator (78) for producing electricity.

### CROSS REFERENCE TO RELATED APPLICATIONS

This application claims priority to U.S. provisional patent application no. 60/568,053 filed 3 May 2004, which is hereby incorporated by reference in its entirety as though fully set forth herein.

### BACKGROUND OF THE INVENTION

1. Field of the Invention

This invention relates to wind-driven turbines for generating electrical energy.

2. Description of the Related Art

Wind has been harnessed as a source of power to perform work for many centuries. The first windmills were developed to automate the tasks of grain-grinding and water-pumping. The earliest-known design of a wind turbine is a vertical axis windmill developed in Persia about 500-900 A.D. Persian windmills were designed with vertical sails made of bundles of reeds or wood that were attached to the central vertical shaft by horizontal struts. To grind grain a grinding stone was affixed to the vertical shaft. The mill machinery was commonly enclosed in a building, which also featured a wall or shield to block the incoming wind from slowing the side of the drag-type rotor that advanced toward the wind.

The Dutch are generally regarded as the primary developers of significant improvements to the design of wind turbine mills. The Dutch affixed a standard horizontal axis post mill to the top of a multi-story tower, with separate floors devoted to grinding grain, removing chaff, storing grain, and (on the bottom) living quarters for the windsmith and his family. Both the post mill and the later tower mill design had to be oriented into the wind manually, by pushing a large lever at the back of the mill. Optimizing windmill energy and power output and protecting the mill from damage by furling the rotor sails during storms were among the windsmith's primary jobs. A primary improvement of the European mills was their designer's use of sails that generated aerodynamic lift. This feature provided improved rotor efficiency compared with the Persian mills by allowing an increase in rotor speed, which also allowed for superior grinding and pumping action.

The most common types of wind-turbine designs in present commercial operation follow the Dutch design and are three-bladed, propeller-type turbines and two-bladed, propeller-type turbines wherein one end of each blade is mounted on a horizontal shaft. Three-bladed wind turbines are operated with the blades facing into the wind. Two-bladed wind turbines, in contrast, operate downwind. Alternatively, modem vertical axis rotor designs are also being pursued. The development of modern vertical-axis rotors was begun as early as the 1920s. These designs generally incorporate a rotor comprising slender, curved, airfoil-section blades attached at the top and bottom of a rotating vertical tube.

A wind turbine works the opposite of a fan. Instead of using electricity to make wind, like a fan, wind turbines use wind to make electricity. The wind turns the blades, which spin a shaft connected to a generator wherein electric current is induced by the rotation of a rotor coil in a magnetic field. Utility-scale turbines range in size from 50 kilowatts to a few megawatts. Single, small turbines, e.g., below 50 kilowatts, are used, for example, for remote homes, telecommunications dishes, or water pumping.

Currently, utility-scale wind turbines can produce electricity for about 4¢ per kilowatt-hour (kWh) on class 6 wind sites (sites with average wind speeds of 6.7 meters per second at 10 meter height-16 miles per hour at 33 feet height). However, as more sites are developed, easily accessible prime Class 6 sites are disappearing. In addition, many Class 6 sites are located in remote areas that do not have easy access to transmission lines.

Class 4 wind sites (sites with average wind speeds of 5.8 meters per second at 10 meter height-13 miles per hour at 33 feet height) cover vast areas of the Great Plains from central and northern Texas to the Canadian border. Class 4 sites are also found along many coastal areas and along the shores of the Great Lakes. While the average distance of Class 6 sites from major load centers is 500 miles, Class 4 sites are significantly closer, with an average distance of 100 miles from load centers. Thus, utility access to the Class 4 sites is more attractive and less costly. Also, Class 4 sites represent almost 20 times the developable wind resource of Class 6 sites. Currently wind energy at Class 4 sites can be marketed at prices in the range of 5 to 6¢/kWh. National Renewable Energy Laboratory, Developing Low Wind Speed Turbines, at http://www.nrel.gov/wind/about_lowspeed.html (last visited Apr. 14, 2004).

The wind turbine propeller and its translation to the rotor systems may be the single most important element of turbine design. The propeller design sets the power extracted from the wind and drives critical aspects of turbine loads and dynamics. Current three-bladed upwind rigid designs, although well understood, may place limitations on loads for future machines. A wide range of alternate design approaches have been proposed that alter one or many aspects of propeller configuration, including number of blades, downwind operations, teetering, flapping, flexing, and many system control and feedback approaches designed to reduce peak and fatigue loads. However, to date, all significant investigations and improvements have been directed to improving the efficiency of propeller-type turbines.

Most of the two or three blade turbine designs at present have increased the size of the turbine to increase power generation capacity. However, this increased size results in greater materials costs, greater weight, and greater noise, without much improvement in energy generation efficiency. Such turbines cannot operate at low wind speeds, e.g., under 10 mph, and once the wind speed reaches over 10 mph, a motor is required to initiate the rotation of the blades. Further, such turbines are unable to operate in high wind environments, e.g., at wind speeds over 65 mph. Additionally, such turbines have shaft rotation speeds of 30 to 60 rotations per minute. In contrast the rotational speed required by most generators to produce electricity is 1,200 to 1,500 rpm, which is 20 to 50 times greater than the turbine speed. Therefore, a gear box must be interposed between the turbine shaft and the rotor of the generator in order to step up the rotational speed imparted by the turbine shaft. However, the gear box significantly reduces the efficiency of transfer of kinetic to electrical energy.

The information included in this Background section of the specification, including any references cited herein and any description or discussion thereof, is included for technical reference purposes only and is not to be regarded subject matter by which the scope of the invention is to be bound.

### SUMMARY OF THE INVENTION

The present invention is directed to an electric generation system composed of an array of novel wind-driven turbines mounted on a platform positioned on top of a tower. Each turbine has a plurality of sigmoid blades mounted parallel to and extending radially outward from at least one horizontally oriented shaft. Each turbine shaft may be connected directly with a generator for producing electricity.

Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is an isometric view of a wind-driven turbine according to one embodiment of the invention.

FIG. 2 is an exploded detail view of the attachment of a blade to a rim of the wind-driven turbine of FIG. 1.

FIG. 3 is a detail view of the attachment of the blades to the hub of the wind-driven turbine of FIG. 1 with one of the blades removed and the shaft shown in phantom.

FIG. 4 is an isometric view of a blade of the wind-driven turbine of FIG. 1.

FIG. 5 is a right elevation view of the blade of FIG. 4.

FIG. 6 is an exploded isometric view of the hub, rim, and spoke assembly of the wind-driven turbine of FIG. 1.

FIG. 7 is a cross-section view taken along line 7-7 as indicated in FIG. 1 of a portion of the wind-driven turbine of FIG. 1 including the interface between the shaft and hub.

FIG. 8 is an isometric view of a pair of coupled wind-driven turbines driving a pair of generators according to another embodiment of the present invention.

FIG. 9 is an isometric view of a pair of wind-driven turbines mounted on a tower platform according to an additional embodiment of the invention.

FIG. 10 is an isometric view of an array of wind-driven turbines mounted on a tower platform according to a further embodiment of the invention.

### DETAILED DESCRIPTION OF THE INVENTION

The invention disclosed herein is a novel wind-driven turbine system for generating electricity. In contrast to the propeller-like turbine designs dominating the contemporary wind power generation industry, the present invention presents a novel turbine design and generator linkage. Each turbine has a plurality of sigmoid blades mounted parallel to and extending radially outward from a horizontally oriented shaft. Each turbine shaft may be connected directly with a generator rotor, rather than via a transmission, for producing electricity. The invention may include an array of such wind-driven turbines mounted on a platform positioned on top of a tower.

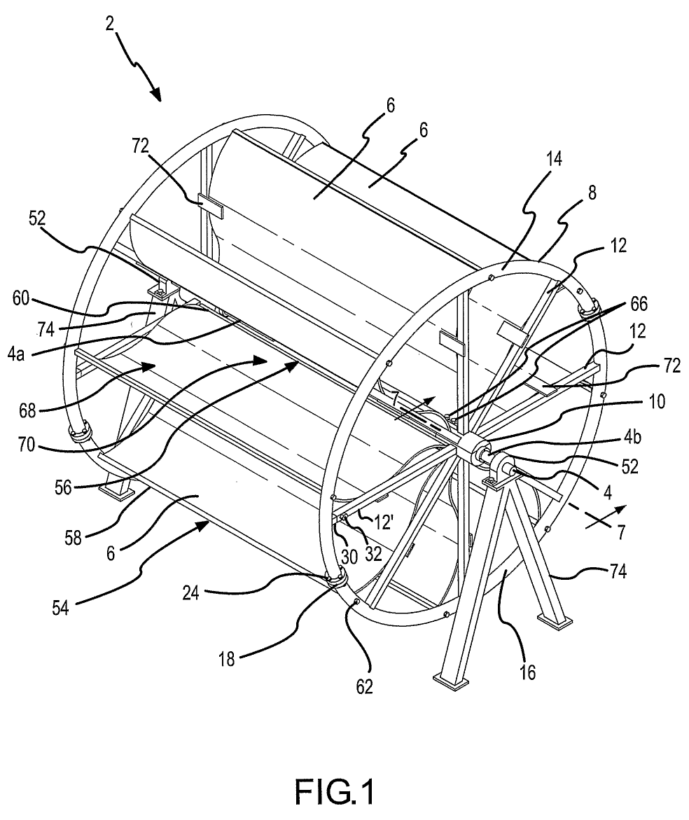

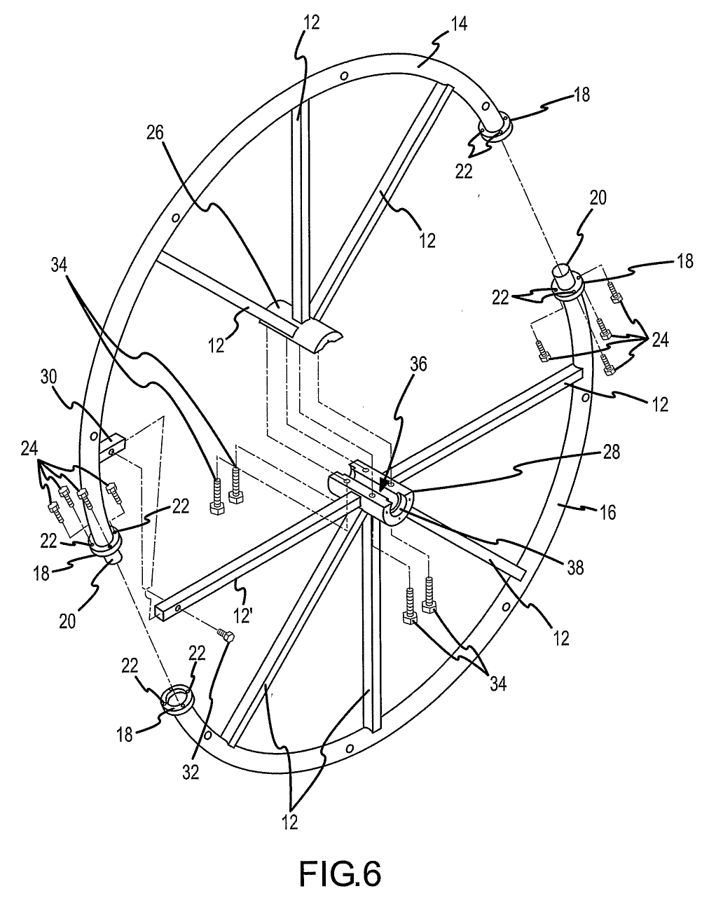

FIG. 1 depicts a turbine 2 for use in a wind-driven turbine system according to one embodiment of the present invention. The major components of the turbine 2 include a shaft 4, a plurality of blades 6, a pair of rims 8 at opposing ends of the blades 6, a pair of hubs 10 centered within each of the rims 8, and a plurality of spokes 12 within each rim 8 corresponding to the number of blades 6 and extending radially from each hub 10 to each rim 8. In the depicted embodiment the rims 8 may be approximately twelve feet in diameter. The rims 8 are composed of two halves, a first rim half 14 and a second rim half 16, fastened together, as shown to good advantage in FIG. 6. Each rim half 14, 16 may be composed of a steel tube of circular cross-section bent into a semi-circular arc. Each end of each rim half 14, 16 forms a flange 18 for mating the first rim half 14 with the second rim half 16. One end of each of the first and second rim halves 14, 16 is provided with a rim plug 20 of a slightly smaller outer diameter than the inner diameter of steel tube forming the rim halves 14, 16. Each rim plug 20 seats within the inner diameter of the opposing flange 18 and rim half. Each rim flange 18 defines four apertures 22 equally spaced about the circumference of the tube forming the rim halves 14, 16. The apertures 22 of opposing rim flanges 18 align with each other and accommodate rim flange bolts 24 to secure the opposing rim flanges 18 of the first and second rim halves 14, 16 together.

As previously indicated, a hub 10 or housing is positioned within the center of each rim 8. The hub 10 is composed of two asymmetrical pieces, a lesser hub housing 26 and a greater hub housing 28. A plurality of spokes 12, eight in the depicted embodiment of FIGS. 1 and 6 is affixed to the hub 10 and each extends radially outward from the hub 10, and the opposite ends of each of the plurality of spokes 12 are affixed to the rim 8. Each of the spokes may be a length of steel tubing with a square cross section, although other cross-sectional shapes may also be used. The turbine 2 may have up to ten spokes 12 on each rim 8. Each spoke 12 is spaced apart an equiangular distance from each adjacent spoke 12. Each of the spokes 12 is affixed to the outer surface of the hub 10 and spaced equidistance from each end of the hub 10. All eight of the spokes 12 are affixed to the hub 10. Three of the spokes 12 are affixed, for example, by a weld, to the lesser hub housing 26 and five of the spokes 12 are affixed, for example, by a weld, to the greater hub housing 28. Four of the spokes 12 attached to the greater hub housing 28 are affixed, for example, by a weld, at the opposing ends to the second rim half 16. The three spokes 12 attached to the lesser hub housing 26 are similarly affixed, for example, by a weld, at the opposite ends to the first rim half 14.

The eighth spoke is a detachable spoke 12′. Although welded to the greater hub housing 28, the detachable spoke 12′ is removably attached to the first rim half 14. The first rim half 14 may have a spoke plug 30 extending radially inward at a position on the first rim half 14 aligned with the radially-extending end of the detachable spoke 12′. The sidewall dimensions of the spoke plug 30 may be slightly smaller than the sidewall dimensions of the detachable spoke 12′ whereby the detachable spoke 12′ may fit over the spoke plug 30 and be attached to the spoke plug 30 by a spoke bolt 32. Alternately, the side wall dimensions of the spoke plug 30 and the detachable spoke 12′ may be reversed and the detachable spoke 12′ may fit within the spoke plug 30. In another embodiment, the detachable spoke 12′ may be attached to the first rim half 14 by a U-bracket (not shown) fitted about the first rim half 14 with each leg of the U-bracket bolted to the eighth spoke 12′. The U-bracket may further be welded or bolted to the first rim half 14 to maintain a fixed position on the first rim half 14.

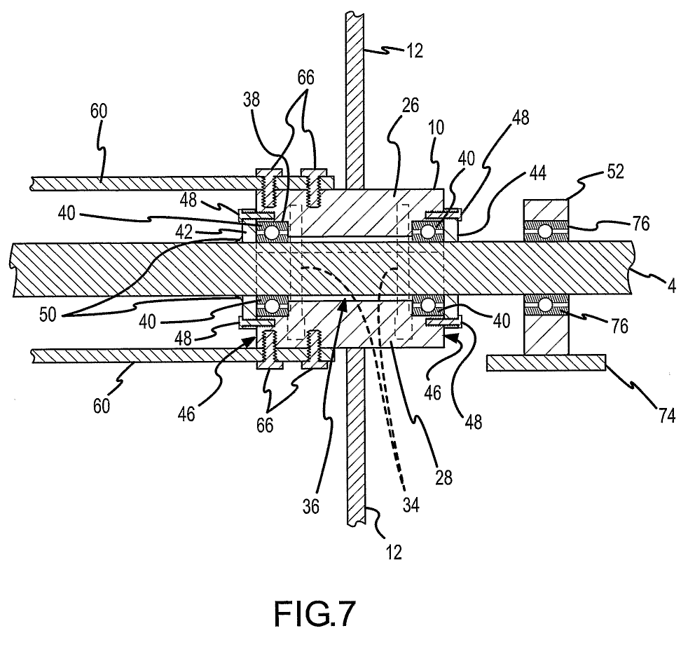

As indicated above, the hub 10 is designed to split into two asymmetric parts, the lesser hub housing 26 and the greater hub housing 29, along a cord plane extending through the cylinder defining the hub, as shown to good advantage in FIGS. 6 and 7. The lesser hub housing 26 and the greater hub housing 28 may be held together by four hub housing bolts 34. Because of the asymmetric structure of the parts of the hub 10, the asymmetric spoke design of the first and second rim halves 14, 16 and the rationale for designing the detachable spoke 12′ to be removably attached to the first rim half 14 becomes apparent. In particular, because the lesser hub housing 26 has a smaller arc length, only three spokes 12 are able to be attached thereto. In contrast, the greater hub housing 28 has a larger arc length and can accommodate the remaining five spokes 12. However, it is desirable for the structural strength of each of the first and second rim halves 14, 16 that they each be supported by an equal number of spokes 12. Thus, when each of the hub 10 and the rim 8 are disassembled, the greater hub housing 28 is attached to the second rim half 16 only by four spokes and the lesser hub housing 24 is attached to the first rim half 14 by the three remaining spokes 12. The last spoke, the detachable spoke 12′, additionally extends from the greater hub housing 28, but is not permanently affixed to either of the first or second rim halves 14, 16. In this manner, each of the first and second rim halves 14, 16 is supported by an equal number of spokes, notwithstanding the asymmetric housing parts o the hub 10.

In the embodiment depicted in FIG. 1, the shaft 4 is actually composed of a left shaft 4a and a right shaft 4b, each positioned within separate hubs 10 on each end of the turbine 2. The shaft 4 is split into two pieces to promote easy assembly and disassembly of the turbine system, for example, for maintenance purposes. Alternately, the shaft 4 may be of unitary construction (not shown) and span the distance between each hub 10 and rim 8 set. In a further embodiment (not shown), a shaft sleeve may be inserted between and around, and coupled with, each of the interior lateral ends of each of the left and right shafts in order to link the left and right shafts together. Each of the left and right shafts 4a, 4b extends through an axial bearing aperture 36 within the center of each hub 10. Each of the left and right shafts 4a, 4b is coaxially aligned within its respective hub 10.

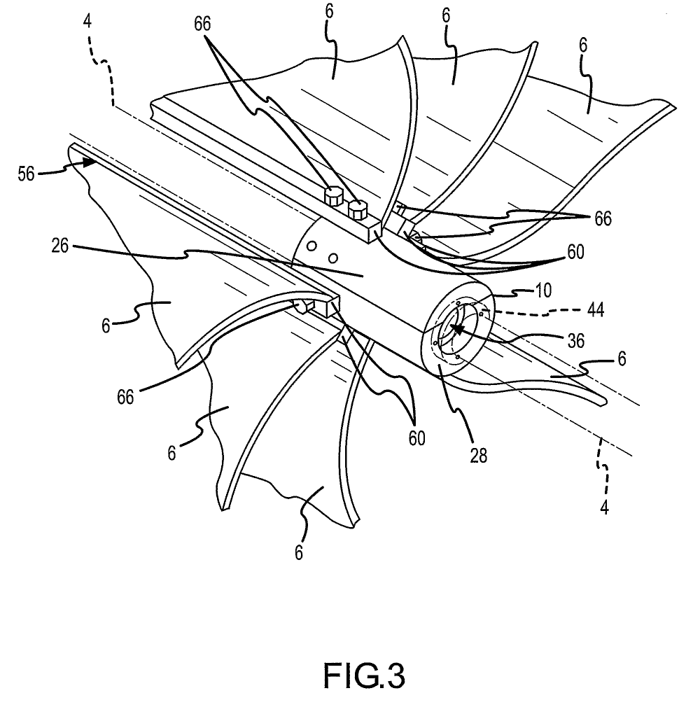

As shown in FIGS. 3, 6, and 7, the bearing aperture 36 of each hub 10 is formed as a central bore hole of a first diameter that flares at each end of the hub 10 to form circular wells of a second, greater diameter. The wells act as bearing seats 38 for sealed circular shaft bearing races 40. The radial wall depth of each shaft bearing 40 is greater than the radial depth of the bearing seats 38 measured radially from the perimeter of the central bearing aperture 36. The diameter of each of the shafts 4a, 4b is less than the diameter of the central bearing aperture 36 of the hubs 10, but is equal to the inner diameter of the shaft bearing 40. Thus, the shafts 4a, 4b are supported within the hubs 10 by the shaft bearings 40. However, while the shafts 4a, 4b do sit on the shaft bearing races 40, the shafts 4a, 4b actually do not rotate within and with respect to the hub 10. The purpose of as the shaft bearings 40 is primarily to allow the shafts 4a, 4b to be easily inserted within and removed from bearing apertures 36 in the hubs 10 as further described below.

A pair of circumferential, donut-shaped shaft flanges, identified individually as an inner shaft flange 42 and an outer shaft flange 44, are positioned on each end of the shafts 4a, 4b. Each of the shaft flanges 42, 44 aligns with each of the bearing seats 38 in the hubs 10 and seats against the end face of the hub 10 to hold the circular shaft bearing races 40 within each of the bearing seats 38. The outer diameter of the shaft flanges 42, 44 is greater than the diameter defined by the well of the bearing seat 38 in the hub 10. Each of the shaft flanges 42, 44 is fastened to a respective end face of the hub 10 by four shaft flange bolts 48. Each of the shaft flanges 42, 44 may be integrally formed with the shaft 4, may be permanently affixed to the shaft 4, may be removably affixed to the shaft 4, or may merely surround the shaft 4 without connection.

In the embodiment depicted in FIG. 7, the outer shaft flange 44 is not affixed to the shaft 4 while the inner shaft flange 42 is permanently affixed to the shaft 4, for example, by a weld as indicated by the weld seam 50. Thus, the blades 6 are attached to the hub 10, the hub 10 is attached to the inner shaft flange 42, and the inner shaft flange 42 is attached to the shaft 4. Through this series of connections, the rotational motion of the blades 6 is thereby transferred to the shaft 4. Because the shaft 4 is only permanently affixed to the inner shaft flange 42, the shaft 4 may be removed from the hub 10 and an adjacent supporting pillow block 52 by merely removing the shaft flange bolts 48 from the inner shaft flange 42 and pulling the shaft 4 axially inward out of the hub 10 and the pillow block 52 on the shaft bearings 40. Because the outer shaft flange 44 is not affixed to the shaft 4, the shaft 4 may be pulled through the outer shaft flange 44 as well as the hub 10. This allows for ease of maintenance of the turbine system.

In the embodiment of the invention depicted in FIG. 1, the turbine 2 is composed of eight blades 6. Each of the blades 6 is identical in size and form. In an experimental embodiment, each blade 6 was designed approximately 6 feet wide and 10 feet long. The blade 6 are mounted in the turbine 2 with the lengths of the blades 6 parallel to the axis of the shaft 4. One of the length-wise edges of each blade 6 is connected with the rim 8. This edge is considered the leading edge 54. The opposite length-wise edge of each blade 6 is connected with each of the hubs 10. This edge is considered the trailing edge 56 of the blade 6. The leading edge 54 of the blade 6 is attached to a leading edge support 58. The leading edge support 58 may be a length of steel tubing of square cross-section that is welded along the leading edge 54 of the blade 6. Similarly, the trailing edge 56 of the blade is attached to a trailing edge support 60. The trailing edge support 60 may likewise be a length of steel tubing of square cross-section welded along the trailing edge 56 of the blade 6.

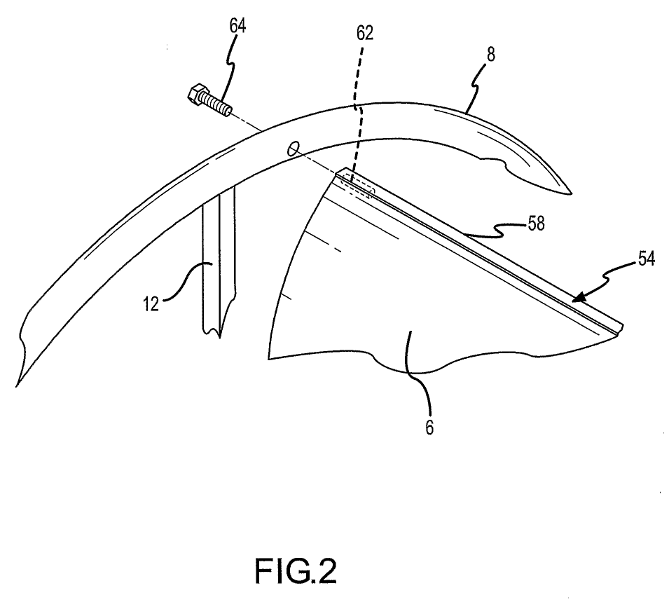

As shown to good advantage in FIG. 2, a plurality of rim nuts 62 may each be welded to or within a corresponding opposing end of each of the leading edge supports 58. A plurality of apertures are formed within the rim 8 corresponding to the position of each of the rim nuts 62 on each leading edge support 58. A plurality of corresponding rim bolts 64 are inserted into and through the apertures in the rim 8 and are fastened to corresponding rim nuts 62 in the leading edge supports 58 of each blade 6. As shown to good advantage in FIG. 3, a pair of apertures are formed in each lateral end of each trailing edge support 60 through which each trailing edge support 60 is mounted to each of the hubs 10. Hub bolts 66 are placed through each pair of apertures in the trailing edge supports 60 and are tightened into threaded apertures within the outer surface of the hub 10 to fasten the trailing edge support 60 to each hub 10.

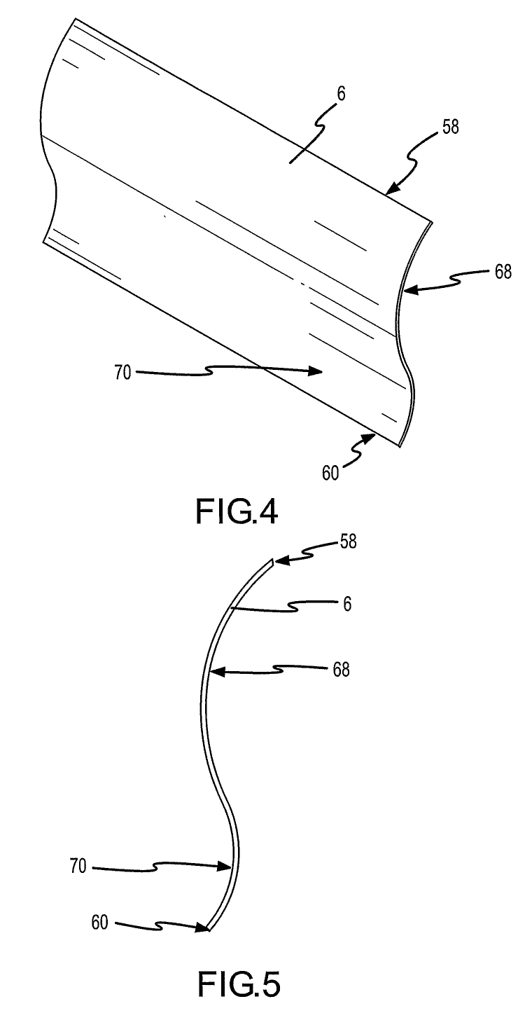

As shown in FIGS. 1, 4, and 5, each of the blades 6 is formed in an air-foil shape with a leading curve 68 transforming into a trailing curve 70. The leading curve 68 is adjacent the leading edge 54 of the blade 6 while the trailing curve 70 is adjacent the trailing edge 56 of the blade 6. The leading curve 68 and the trailing curve 70 define concavities within the blade 6 on opposing sides of the blade 6 such that the blade takes the form of a sigmoid shape when viewed from a lateral end of the blade 6, as in FIG. 5. In experimental embodiments conforming to the blade dimensions previously described, the radius of curvature of the leading curve 68 may be between about 35 inches and 50 inches and the radius of curvature of the trailing curve 70 may be between 20 inches and 30 inches. In an experimental embodiment generally conforming to the depictions in FIGS. 1, 4, and 5, the radius of curvature of the leading curve 68 is about 42.125 inches and the radius of curvature of the trailing curve 70 is about 25.25 inches. The leading curve 68 transitions into the trailing curve 70 at a point approximately two-thirds of the width of the blade 6 from the leading edge 68 of the blade 6.

Each spoke 12 is welded to the hub 10 immediately adjacent to the location that each trailing edge support 60 of each blade 6 is fastened to the hub 10. Each blade 6 and each spoke 12 extend in a radial direction from each hub 10 generally adjacent to each other toward the rim 8. Because of the leading curve 68 and the trailing curve 70 formed in each blade 6, the point at which each spoke 12 is affixed to the rim 8 is spaced apart from the point at which each leading edge support 60 is bolted to the rim 4. The convex side of the leading curve 68 is positioned adjacent to one side of the corresponding spoke 12. A spoke plate 72 is welded to the apex of the concave side of the leading curve 68 and also to the corresponding edge of the adjacent spoke 12 in order to provide additional structural support to each blade 6. As the diameter of the hub 10 is larger than the diameter of the shaft 12, the trailing edge 70 of each blade 6 is spaced apart from the shaft 12 extending between each hub 10 of the turbine 2.

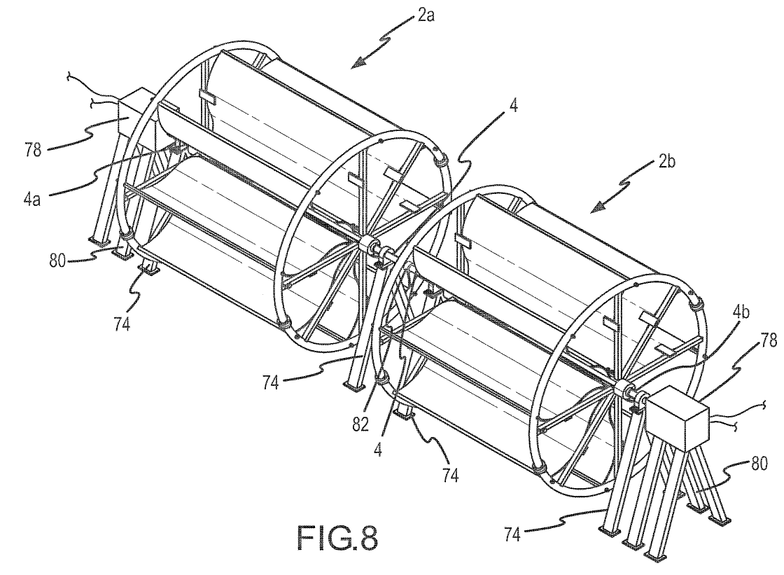

As shown in FIG. 1, each shaft 12 extends laterally outward from each hub 10 and passes through a pillow block 52 that rotationally supports the turbine 2. Each pillow block 52 is mounted upon a shaft stand 74, which provides a surface for mounting the pillow block 52 and thereby vertically supports the turbine 2. In the embodiment disclosed herein, each shaft stand 74 is an A-frame support structure with two steel legs. Each shaft stand is taller than the radius of the rims 8 of the turbine 2, thereby supporting the turbine 2 above a platform surface, upon which each shaft stand 74 rests. This allows the shaft 4 of the turbine 2 to freely rotate within a ring bearing 76 in the pillow block 52. The shaft 4 further extends laterally beyond each of the pillow blocks 52 a sufficient distance such that it may be coupled with a rotor shaft (not shown) extending from a generator 78 (see FIG. 8) or with another opposing corresponding rotor shaft from an adjacent turbine 2 as further described below. By coupling the turbine shaft 4 to the rotor of a generator 78, the kinetic energy of the turbine 2 is transformed into electrical energy by the generator 78. As the only resistance on the shaft 4 other than the generator rotor, is the ring bearing 76 in the pillow block 52, the turbine 2 is free to rotate, and be caused to rotate even at very low wind speeds, without the drag and friction of intervening gears, transmissions, and other support structures.

In one embodiment of the invention an exemplary generator 78 may be a variable speed generator with a three-stage stator and a permanent magnet rotor assembly. The generator 78 may also be designed for bi-directional rotation and be externally commutated. The stator, field-windings, and core are preferably sealed to prevent air, humidity, or other contamination from infiltrating the generator 78. Such an exemplary generator 78 may have a power rating of 240 kW at 200 rpm, 120 kW at 100 rpm, and 60 kW at 50 rpm. A no load runaway speed may be approximately 300 rpm. The generator 78 may have a rated torque of approximately 8000 ft-lbs and a cogging or starting torque of approximately 80 ft-lbs. The generator 78 may have an efficiency of approximately 95% or greater. Each generator 78 is electrically connected with a power transfer line connecting the wind-driven turbine system to an electrical grid.

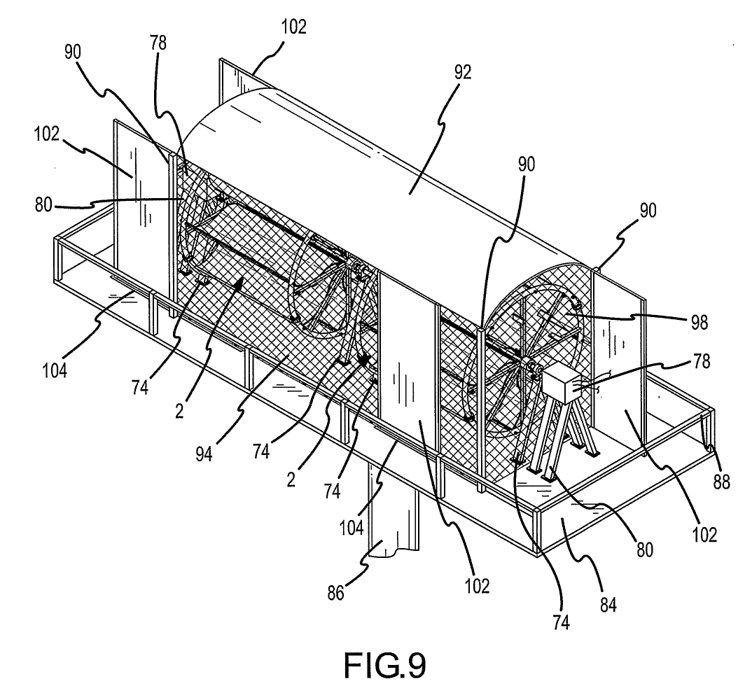

The generator 78 may be mounted upon one or more generator stands 80 as shown in FIGS. 8 and 9, which may be similar in construction to the shaft stands 74. For example, the generator stands 80 may be steel A-frame supports at the apex of which the generator 78 is mounted. The generator 78 is mounted on the generator stands 80 at a height such that the rotor shaft (not shown) emerging from the generator 78 is axially aligned with the turbine shaft 12. The rotor shaft of the generator 78 may be directly coupled with the turbine shaft 12 via a rotor coupler (not shown). In an alternative embodiment, a gearbox (not shown) may be interposed between the turbine shaft 12 and the rotor shaft in order to provide a stepped-up gear ratio between the turbine shaft 12 and the rotor shaft. In the case of application of the turbine system in an area with very low wind speeds, the gear box may increase the rotational frequency of the rotor shaft within the generator 78 allowing for generation of electricity at such low wind speeds. In a further embodiment, each of the left and right 12 shafts of a turbine 2 may be attached to separate generators 78.

In some embodiments, as in FIG. 8, the turbine is part of an array of turbines 2a, 2b. In such an embodiment, if a second turbine 2b is mounted immediately adjacent to a first turbine 2a, and the adjacent shafts 4 of the turbines 2a, 2b are aligned, the adjacent shafts 4 between the turbines 2a, 2b may be coupled together with a shaft coupler 82. As depicted in FIG. 8, the right lateral end of the right shaft 46 of the right turbine 2b is coupled with a rotor shaft (not shown) extending from a first electrical generator 78. Similarly, the left lateral end of the left shaft 4a of the left turbine 2a is coupled with a rotor shaft (not shown) extending from a second electrical generator 78. The shaft coupler 82 synchronizes the adjacent shafts 4, and thus the adjacent turbines 2, whereby the rotor shafts of generators 78 coupled to each of the outside ends of the shafts 4 rotate at the same speed.

As shown in FIG. 9, one or more turbines 2 and attached generators 78 may be positioned on a platform 84 on top of a tower 86 up to a few hundred feet high (e.g., 200 feet) either singularly or in an array of a plurality of like turbines 2. The tower 86 may be of lattice or tubular construction. The platform 84 may be affixed to the top of the tower 86 either stationary or atop an intervening yaw system (not shown) to allow the platform 84 to rotate about the top of the tower 86 in either angular direction to orient the turbines 2 into the wind. The platform 84 may be provided with a safety railing system 88 around its perimeter to provide for the safety of workers installing or servicing the turbines 2 mounted thereon.

As shown in FIG. 9, two identical turbines 2 and two generators 78 are mounted on a platform 84 on shaft stands 74 and generator stands 80, respectively. Mounting turbines 2 in pairs is desirable as one turbine 2 can still operate even if the other turbine 2 is taken offline for maintenance. A plurality of pillars 90 are mounted to the platform 84 and extend vertically to a height above the height of the mounted turbines 2. A roof 92 may be mounted on the pillars positioned above the pair of turbines 2 to provide some protection to the turbines 2 from rain, snow, or other weather conditions. The roof 92 as shown in FIG. 9 is arcuate, but it may take any desired form for a roof, e.g., flat, pitched, peaked, etc. The roof panel 92 may also extend laterally to a width such that it additionally covers the generators 78. Alternately, each of the generators 78 may be provided with individual covers or other wise be constructed to be weather resistant.

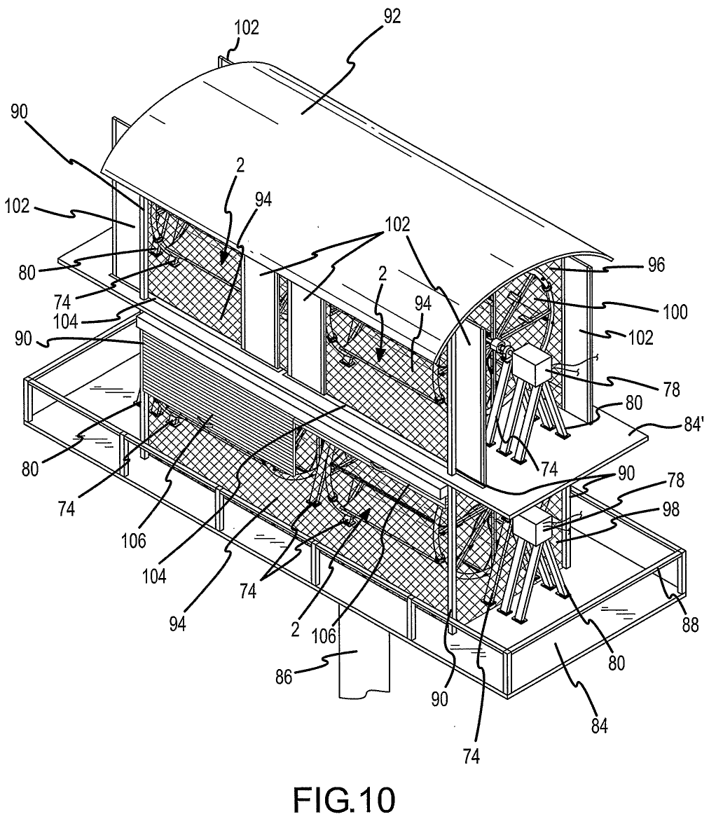

An array of towers 86 supporting turbines 2 may be arranged in close proximity to provide a desired amount of power generation to the power grid from a particular geographic area. Additionally or alternately, as shown in FIG. 10, the pillars 90 on the platform 84 supported by the tower 86 may alternately support a second platform 84′ positioned above a first pair of turbines 2 to support a second pair of turbines 2 and generators 78. The pillars 90 in this embodiment need to be sufficiently strong to support the weight of the second pair of turbines 2 and generators 78. The arrangement of the first and second pairs of turbines 2 in FIG. 10 is identical in all respects to the arrangement of the single pair of turbines 2 previously described with respect to FIG. 9. A second set of support pillars 90 on the second platform 84′ support a solid, arcuate roof 92 positioned above the second pair of turbines 2 to provide some protection to the turbines 2 from rain, snow, or other weather conditions. The roof panel 92 may also extend laterally to a width such that it additionally covers the generators 78.

A front screen 94 and a rear screen 96 (see FIG. 10) span between the pillars 90 on both the front side and the back side of each pair of turbines 2 in both FIG. 9 and FIG. 10. In FIG. 9 the front screen 94 and the rear screen 96 extend from the platform 84 to the roof 92 and laterally at least as wide as the pair of turbines 2. In FIG. 10, a first front and rear screen 94, 96 extend from the platform 84 to the underside of the second platform 84′. A second front and rear screen 94, 96 extend from the second platform 84′ to the roof 92. The front and rear screens 94, 96 may be made of wire mesh or steel mesh panels and are provided to prevent trash or other articles from being blown into the turbines 2 and to prevent birds from flying into or nesting within the turbines 2. Side screens 98 may be similarly be used to span the distance between the front and the rear screens 94, 96 on each side of the pair of turbines 2. The side screens 88 may be hinged panels to allow maintenance access to the turbines 2. The generators 78 may be housed within or outside of the side screens 98.

Alternatively, as shown with respect to the upper pair of turbines 2 in FIG. 10, the area bounded by each of the rims 8 of the turbines 2 may also be covered by wire mesh or steel mesh rim screen panels 100 in order to prevent articles from blowing into the blades 6 of the turbines 2. These rim screen panels may be a collection of pie-shaped panels for ease of assembly and extend between each of the turbine spokes as shown. The rim screen panels 100 may be attached to each of the spokes 12 by bolting them thereto. Because the rim screens 100 are permeable to the wind, once the air passes through the turbine 2, the air is evacuated from the area rather than trapped and thereby does not cause dead pockets or eddies that would create drag on the turbine.

Front and rear wind-break panels 102 may be further provided on the platform 84 as depicted in FIG. 9. Each wind-break panel 102 is mounted within upper and lower sliding tracks 104 positioned on the under side of the roof 92 (or upper platform 84′ in FIG. 10) and on the platform 84, 84′, respectively. The width of each sliding wind-break panel 102 may be up to half the width of a turbine 102 or more. The sliding wind-break panels 102 may be moved within the tracks 104 in front of the turbines 2 by hydraulic or electromechanical actuation in order to reduce the volume of airflow impacting the turbine blades 6. The movement of the panels 102 to cover the turbines 2 may be actuated by a controller upon input of wind speed from an wind speed monitoring device. As the velocity of the wind reaches threshold levels, the panels 102 may be moved in front of the turbines 2 in a graduated manner. A reduction in air volume may be desirable, for example, in high wind speed environments in order to reduce the volume of wind impacting the turbine blades 6, and thereby the translated rotational velocity of the turbine shaft 12, and allow the turbines 2 to continue to operate rather than having to shut them down for fear of mechanical failure or generator overload. It may be desirable to center each wind-break panel 102 equidistant between the rims 8 of each respective turbine 2 in order to balance the air flow impacting the turbine blades 6 and minimize the possibility of excessive lateral torque being placed upon one of the left or right turbine shafts 12.

In an alternate embodiment as shown with respect to the top pair of turbines 2 in FIG. 10, each turbine 2 may be provided with a pair of wind-break panels 102 that are introduced in front of the turbine 2 from each lateral side of the turbine 2. Such a pair of panels 102 when introduced in front of the turbine 2 in equal proportions would ensure that airflow impacting the turbines 2 is consistently directed to the center of the turbine blades 6, thereby minimizing excessive torque placed on either the left or right shaft 12. Utilizing a pair of wind-break panels 102 for each turbine 2 in this manner further allows for balanced lateral diversion of the airflow along the length of each turbine blade 6. In yet another alternative embodiment as depicted in FIG. 10, a rolling shutter 106 may be mounted under the upper platform 84′ (or under the roof 92) and positioned in front of the turbine 2. In this embodiment, the rolling shutter 106 may be opened downwardly in front of the turbine 2 to similarly restrict airflow without creating unbalanced torque on either the left or right shaft 12. A rolling shutter 106 that spans the distance between the platform 84 and roof 92 may be desirable in environments subject to extremely high wind velocities in order to effectively inhibit turbine rotation and prevent damage to the turbine 2 or attached generator 78.

As noted each of the blades 6 is designed as an airfoil adapted to induce rotation in the turbine 2 at both very low wind speeds and when the angle of incidence of the wind is not directly normal to the turbine blades 6. The turbines 2 are generally positioned such that the faces of the turbine blades 6 are generally oriented substantially normal to the prevailing direction of the winds. In this manner, the leading curve 68 of the blade 6 acts as a bucket to collect the incident air volume of the wind. The pressure imparted by the wind initiates the spinning of the turbine 2 on the shaft 12. When the wind is blowing toward the front of the turbine 2, the leading edge 54 of the blade 6 is forced downward. Viewing the turbine 2 from the right side, as depicted in the drawings, the turbine 2 will rotate in a counter-clockwise direction. Additionally because of the airfoil shape of the blades 6, winds instant from the lateral ends of the turbines 2 also initiate rotation of the turbines 2 as the blades 6 are motivated by the wind in a manner similar to that of a flywheel.

In addition to the wind pressure pushing the leading curve 68 of the blade 6 in a downward direction, excess pressure forces air out of each end of the space defined between adjacent blades 6. As viewed from the front of the turbine 2, the upward curvature of the leading edge 54 of the turbine blade 6 partially shields the wind from entering the pocket between a lower turbine blade and an upper turbine blade until the lower turbine blade is at an angle such that the incidence of the wind upon the lower blade will force it in a downward direction. The upward curvature of the leading edge 54 of the blade 6 therefore ensures that the rotation of the turbine 2 will always be in the same downward direction when viewed from the front.

As the blades 6 rotate downward and continue toward the rear side of the turbine 2, there is a higher pressure toward the trailing edge 56 of the blade 6 and a lower pressure toward the leading edge 54 of the blade 6 in the pocket between two adjacent blades. This pressure differential is induced by the centripetal force of the turbine 2 exhausting air closer to the leading edge 54 out of the pocket. This high to low pressure differential further causes air flow from the trailing edge 56 to the leading edge 54 of the blade as the pocket attempts to reach a pressure equilibrium. This outward airflow across the blade 6 on the back side of the turbine 2 operates to provide some measure of aerodynamic lift across the leading curve 68.

In addition, as the trailing edges 56 of each of the blades 6 is not attached to the shaft 12, and the shaft 12 does not extend fully between the hubs 10, there is a gap between each of the trailing edges 56 of the blades 6 and the shaft 12. This allows for airflow from the pocket between two adjacent blades 6 on the front side of the turbine 2 to travel through to a pocket between two adjacent and opposing blades 6 instantaneously positioned on the rear side of the turbine 2. This airflow from front-side positioned blades to rear-side positioned blades impacts the concave side of the trailing curve 70 on the backside of the turbine 2, thus pushing the blade 56 on the backside of the turbine 2 in an upward direction and assisting in the counter-clockwise rotation of the turbine 2. In addition, this airflow from the axis of the turbine 2 joins the airflow from the high pressure air at the trailing edge 56 to the low pressure toward the leading edge 54 of the blade 6. This additional airflow increases the aerodynamic lift over the concave side of the leading curve 68. Because the outlet area between adjacent blades 6 on the rear side of the turbine 2 is larger than the inlet area between the blades 6 near the shaft 12, stagnation and choking of the airflow are prevented.

It should also be apparent that should the prevailing winds shift to a direction originating from the rear side of the turbine 2, the blades 6 will capture the wind and rotate the turbine 2 in a similar manner. The rotation of the turbine 2 will still be counter-clockwise as viewed from the right end depicted in the figures. However, in this situation, the leading edge 54 on the back side will be forced upward by the collection of air volume in the leading curve 68. Similarly, the pressure differential and aerodynamic lift effects will be transferred to the blades 6 on the front side of the turbine 2, which will thereby be forced downward.

Although various embodiments of this invention have been described above with a certain degree of particularity, or with reference to one or more individual embodiments, those skilled in the art could make numerous alterations to the disclosed embodiments without departing from the spirit or scope of this invention. It is intended that all matter contained in the above description and shown in the accompanying drawings shall be interpreted as illustrative only of particular embodiments and not limiting. All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the basic elements of the invention as defined in the following claims.

What is claimed is:

1. A wind-driven turbine comprising
at least one horizontally oriented shaft; and
a plurality of sigmoid blades mounted about the at least one shaft, wherein
each of the plurality of sigmoid blades defines a trailing edge;
the trailing edge of each of the plurality of sigmoid blades is oriented parallel to a center axis of the at least one shaft; and
each of the plurality of sigmoid blades extends radially outward from the at least one shaft.

2. The wind-driven turbine of claim 1 further comprising
a first rim attached to a first lateral end of each of the plurality of sigmoid blades and a second rim attached to a second lateral end of each of the plurality of sigmoid blades;
a first hub attached to the first lateral end of each of the plurality of sigmoid blades and a second hub attached to the second lateral end of each of the plurality of sigmoid blades, wherein
each of the first hub and the second hub define a bearing aperture; and
the first hub and second hub are positioned concentrically within the first rim and the second rim, respectively;
a first set of spokes and a second set of spokes, wherein
the first set of spokes extends between the first hub and the first rim; and
the second set of spokes extends between the second hub and the second rim; and
wherein the at least one shaft seats within the bearing aperture of each of the first hub and the second hub, respectively.

3. The wind-driven turbine of claim 2, wherein the at least one shaft is attached to at least one of the first hub and the second hub.

4. The wind-driven turbine of claim 2, wherein the at least one shaft is removably attached to at least one of the first hub and the second hub.

5. The wind-driven turbine of claim 2, wherein each of the first and second hubs is of two-part construction comprising a lesser hub housing and a greater hub housing.

6. The wind-driven turbine of claim 2, wherein each of the first and second rims is of two-part construction comprising a first rim half and a second rim half.

7. The wind-driven turbine of claim 2, wherein
each of the first and second hubs is of two-part construction comprising a lesser hub housing and a greater hub housing;
each of the first and second rims is of two-part construction comprising a first rim half and a second rim half;
half of the first set of spokes is attached to the first rim half of the first rim;
half of the first set of spokes is attached to the second rim half of the first rim;
one more than half of the first set of spokes is attached to the greater hub housing of the first hub;
one less than half of the first set of spokes is attached to the lesser hub housing of the first hub;
half of the second set of spokes is attached to the first rim half of the second rim;
half of the second set of spokes is attached to the second rim half of the second rim;
one more than half of the second set of spokes is attached to the greater hub housing of the second hub; and
one less than half of the second set of spokes is attached to the lesser hub housing of the second hub.

8. The wind-driven turbine of claim 2, wherein
the at least one shaft comprises a first shaft and a second shaft;
the first shaft seats within the bearing aperture of the first hub; and
the second shaft seats within the bearing aperture of the second hub.

9. The wind-driven turbine of claim 1, wherein each of the plurality of sigmoid blades further comprises
a leading edge,
a leading curve adjacent the leading edge, and
a trailing curve positioned between the leading curve and the trailing edge; and
wherein on a first side of each of the plurality of sigmoid blades the leading curve is concave and the trailing curve is convex.

10. A wind-driven turbine comprising
a first shaft and a second shaft, each positioned horizontally with respect to the ground;
a first hub and a second hub, wherein
each of the first and second hub define a respective axial bearing aperture;
the first shaft passes through the axial bearing aperture of the first hub;
the first shaft is removably attached to the first hub;
the second shaft passes through the axial bearing aperture of the second hub; and
the second shaft is removably attached to the second hub;
a first rim and a second rim positioned concentrically about the first hub and the second hub, respectively;
a first set of a plurality of spokes and a second set of a plurality of spokes, wherein
each spoke of the first set of spokes connects with and extends radially between the first hub and the first rim and each spoke of the first set of spokes is spaced at an equiangular distance from each adjacent spoke of the first set of spokes; and
each spoke of the second set of spokes connects with and extends radially between the second hub and the second rim and each spoke of the second set of spokes is spaced at an equiangular distance from each adjacent spoke of the second set of spokes; and
a plurality of sigmoid blades equal in number to one of the sets of spokes, wherein
each blade defines
a leading edge,
a leading curve adjacent the leading edge,
a trailing edge, and
a trailing curve positioned between the leading curve and the trailing edge;
each lateral end of the leading edge of each blade is connected with the first rim and the second rim, respectively; and
each lateral end of the trailing edge of each blade is connected with the first hub and the second hub respectively.

11. The wind driven turbine of claim 10, wherein each lateral end of each blade is positioned in general radial alignment with one of the first set of spokes and one of the second set of spokes, respectively.

12. The wind-driven turbine of claim 11, wherein the leading curve of each blade is attached to a respective one of the first set of spokes and a respective one of the second set of spokes.

13. The wind-driven turbine of claim 10, further comprising a first screen and a second screen mounted to and spanning an area defined by each of the first rim and the second rim, respectively, to protect the wind-driven turbine from birds and blowing debris.

14. A wind-powered electric generation system comprising
an array of wind-driven turbines mounted on a first platform positioned on top of a tower, each wind-driven turbine comprising
a horizontally oriented shaft;
a plurality of sigmoid blades mounted about the shaft, wherein
each of the plurality of sigmoid blades defines a trailing edge;
the trailing edge of each of the plurality of sigmoid blades is oriented parallel to a center axis of the shaft, and
each of the plurality of sigmoid blades extends radially outward from the shaft; and
one or more generators connected with the shafts of each of the wind-driven turbines.

15. The wind-powered electric generation system of claim 14, wherein
two of the turbines in the array of wind-driven turbines are mounted adjacent to each other; and
the respective shafts of the two turbines are coupled together.

16. The wind-powered electric generation system of claim 14, wherein a subset of the array of wind-driven turbines is mounted on a second platform and the second platform is mounted above the first platform.

17. The wind-powered electric generation system of claim 14 further comprising a means for shielding at least a portion of the plurality of sigmoid blades of each of the turbines from incident wind to reduce the volume of wind impacting the plurality of sigmoid blades.

18. The wind-powered electric generation system of claim 17 further comprising
a wind speed monitor; and
a control mechanism coupled with and activated by measurements output from the wind speed monitor, wherein the control mechanism operates the shielding means to increase or decrease the wind volume impacting the plurality of sigmoid blades in response to wind speed.

19. The wind-powered electric generation system of claim 14 further comprising a screen mounted on the first platform about the wind-driven turbines to protect the wind-driven turbines from birds and blowing debris.

20. The wind-powered electric generation system of claim 16 further comprising a screen mounted on the second platform about the wind-driven turbines to protect the wind-driven turbines from birds and blowing debris.

21. The wind-powered electric generation system of claim 14 further comprising a roof mounted on the first platform above the array of wind-driven turbines.
